(19) United States
(12) Patent Application Publication
(10) Pub. No.: US 2005/0270797 A1
(43) Pub. Date: Dec. 8, 2005

(54) Light string with recognizable wires and bulb assemblies

(76) Inventor: Chin-San Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/861,393

(22) Filed: Jun. 7, 2004

(51) Int. Cl. H01R 33/00

(52) U.S. Cl. 362/604; 362/391

(57) ABSTRACT

A light string with recognizable wires and bulb assemblies is composed by several electrical wires. Each wire connects with many bulb assemblies thereon at interval. And each wire with connected bulb assemblies is provided with a specific symbol or color in order that it can be recognized from other wire and bulb assemblies in ease. Hence, if anyone bulb is broken, it will be easily found out belonging to which wire and can be repaired or replaced quickly.

### BACKGROUND OF THE INVENTION

It is known that a conventional light string is composed by several electrical wires, each of which connects with bulb assemblies at interval. By separated control of each electrical wire, a special twinkling effect will be obtained to increase the decorative purpose. The electrical wires with bulb assemblies of the prior light string are all in the same color and have same outlook. If there is one bulb is broken, it is very difficult to recognize the broken one belonging to which electrical wire. The repairing or replacement procedures will be troublesome.

### SUMMARY OF THE INVENTION

The present invention is to provide a light string, which includes several composed wires, each of which has a specific recognizable symbol. Hence, each single wire with connected bulb assemblies of the light string can be recognized very easily. Now, accompanying with the following drawings, the character of the present invention will be described here and after.

### BRIEF DESCRIPTION OF THE DRAWINGS

FIG. 1 is a perspective view showing a part of a light string with recognizable wires and bulb assemblies according to the present invention.

### DETAILED DESCRIPTION OF THE PREFERRED EMBODIMENT

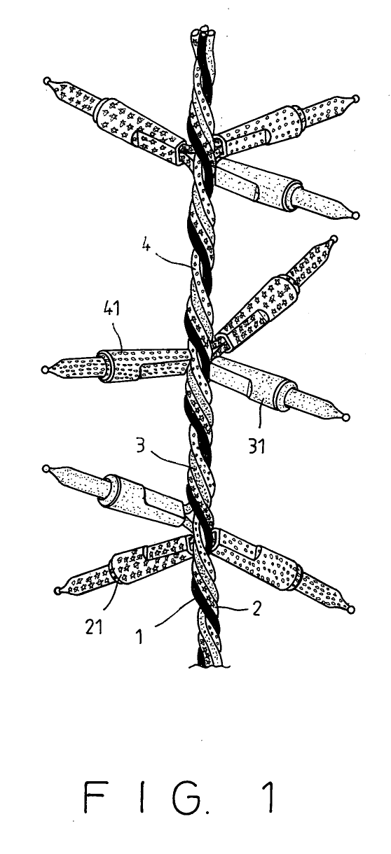

Please referring to FIG. 1, it shows a part of a light string of the present invention, which is composed by a main wire (1), a second wire (2), a third wire (3), and a fourth wire (4). Each wire is provided with a specific color or symbol thereon. Such as in the embodiment of the present invention, the second wire (2) is provided with star symbol, the third wire (3) is provided with dot mark, and the fourth wire (4) is provided with small round symbol. The bulb assemblies (21), (31), (41) are provided with the same symbol as on each connected wire. That is the bulb assemblies (21) have star symbols, the bulb assemblies (31) have dot marks, and the bulb assemblies (41) have small round symbols.

It will be understood that if the recognized basic is by color, the second wire (2) with bulb assemblies (21) is formed a same color. The third wire (3) with bulb assemblies (31) is formed another color, and the fourth wire (4) with bulb assemblies (41) is formed another different color. Furthermore, the light string can also be composed by more or less wires in application, while each wire is provided with recognizable symbol thereon.

Hence, each wire with connected bulb assemblies can be recognized easily in a light string. When anyone bulb is broken, it can be recognized belonging to which electrical wire easily and can be repaired or replaced conveniently. It overcomes the drawback of the prior structure and obtains improvement and utilization.

1. A light string with recognizable wires and bulb assemblies being composed by several electrical wires with connected bulb assemblies, and the improvement is each wire with bulb assemblies connected thereon is provided with a specific symbol or color to be recognized from other wire and bulb assemblies in ease.
